(19) United States
(12) Patent Application Publication
(10) Pub. No.: US 2023/0412286 A1
(43) Pub. Date: Dec. 21, 2023

(54) RADIO NETWORK SYSTEM AND RADIO APPARATUS

(71) Applicant: Panasonic Intellectual Property Management Co., Ltd., Osaka (JP)

(72) Inventors: Hiroshi TAKAHASHI, Kanagawa (JP); Naganori SHIRAKATA, Kanagawa (JP); Tomohiro MURATA, Kanagawa (JP); Koji TAKINAMI, Kanagawa (JP); Yohei MORISHITA, Kanagawa (JP); Mei OKAMOTO, Kanagawa (JP)

(21) Appl. No.: 18/459,865

(22) Filed: Sep. 1, 2023

Related U.S. Application Data
(63) Continuation of application No. PCT/JP2022/008744, filed on Mar. 2, 2022.

(30) Foreign Application Priority Data
Mar. 2, 2021 (JP) 2021-032525

(51) Int. Cl. H04B 17/17; H04B 17/18

(52) U.S. Cl. CPC H04B 17/17; H04B 17/18

(57) ABSTRACT

In a radio network system containing a first radio apparatus that performs central control and a second radio apparatus, the second radio apparatus receives a first signal containing first identification information indicating a transmission source during a first reception period, receives a second signal containing second identification information indicating a transmission source during a second reception period, measures first reception information on reception of the first signal, measures second reception information on reception of the second signal, and transmits first measurement information containing the first reception information and the first identification information and second measurement information containing the second reception information and the second identification information to the first radio apparatus. When the first identification information and the second identification information are the same, the first radio apparatus compares the first reception information and the second reception information to determine whether a radio apparatus in an abnormal condition is present.

### CROSS REFERENCE TO RELATED APPLICATIONS

This application is entitled to (or claims) the benefit of Japanese Patent Application No. 2021-032525, filed on Mar. 2, 2021, the disclosure of which including the specification, drawings and abstract is incorporated herein by reference in its entirety.

### TECHNICAL FIELD

The present disclosure relates to radio network systems and radio apparatuses.

### BACKGROUND ART

In manufacturing premises and factories, sensor information has been increasingly integrated to a server using radio communications, or actuators, such as a server motor, have been controlled using radio communications.

Radio communications have a higher risk of eavesdropping, interception, unauthorized access, or other attacks than wired communications. External attacks on manufacturing facilities used in manufacturing premises or factories can cause production stoppage and/or mixture of defective products.

For example, in radio communications, one radio terminal #X can intercept the operation of another radio terminal #Y and spoofs the radio terminal #Y. The spoofing radio terminal #X is determined to have the same identification information as the impersonated radio terminal #Y and to operate the same as the radio terminal #Y by an access point and/or another radio terminal, which makes it more difficult to detect the unauthorized access of the spoofing radio terminal #X.

For example, PTL 1 discloses a method for detecting an unauthorized radio terminal (device) by setting expected operations of a radio terminal (device).

### CITATION LIST

### Patent Literature

### PTL 1

Japanese Patent No. 6644784

### SUMMARY OF INVENTION

### Technical Problem

However, it is difficult with the method disclosed in PTL 1 to anticipate all of the operations of the radio terminal in advance, and a radio terminal that spoofs an authorized radio terminal imitates the operations of the authorized radio terminal. For this reason, detection with the method of PTL 1 is difficult.

The non-limiting embodiments of the present disclosure contribute to provision of radio network systems and radio apparatuses capable of determining whether a radio apparatus in an abnormal condition, such as being spoofed, is present.

### Solution to Problem

A radio network system according to one example of the present disclosure is a system to which a first radio apparatus performing central control and a plurality of second radio apparatuses connected to the first radio apparatus by radio belong, in which each of the plurality of second radio apparatuses includes: a second receiving circuit configured to receive a first signal containing first identification information indicating a transmission source radio apparatus during a first reception period and to receive a second signal containing second identification information indicating a transmission source radio apparatus during a second reception period different from the first reception period; a measuring circuit configured to measure first reception information on reception of the first signal and to measure second reception information on reception of the second signal; and a second transmitting circuit configured to transmit first measurement information containing the first reception information and the first identification information and second measurement information containing the second reception information and the second identification information to the first radio apparatus, and in which the first radio apparatus includes: a first receiving circuit configured to receive the first measurement information and the second measurement information from each of the plurality of second radio apparatuses; and a condition determining circuit configured to, when the first identification information contained in the received first measurement information and the second identification information contained in the received second measurement information are identical to each other, compare the first reception information contained in the received first measurement information and the second reception information contained in the received second measurement information to determine whether a radio apparatus in an abnormal condition is present.

A radio apparatus according to one example of the present disclosure is an apparatus being a first radio apparatus that belongs to a radio network, the first radio apparatus including: a receiving circuit configured to receive first measurement information and second measurement information from each of a plurality of second radio apparatuses connected to the first radio apparatus, wherein the first measurement information contains first reception information on reception of a first signal received during a first reception period and first identification information contained in the first signal, the first identification information indicating a transmission source radio apparatus, and wherein the second measurement information contains second reception information on reception of a second signal received during a second reception period different from the first reception period and second identification information contained in the second signal, the second identification information indicating a transmission source radio apparatus; and a first condition determining circuit configured to, when the first identification information and the second identification information are identical to each other, compares the first reception information and the second reception information to determine whether a radio apparatus in an abnormal condition is present.

A radio network system according to one example of the present disclosure is a system to which a first radio apparatus that performs central control and a plurality of second radio apparatuses connected to the first radio apparatus by radio belong, in which each of the plurality of second radio apparatuses includes: a second receiving circuit configured to receive a first signal containing first identification information indicating a transmission source radio apparatus during a first reception period and to receive a second signal containing second identification information indicating a transmission source radio apparatus during a second reception period different from the first reception period; a measuring circuit configured to measure first reception information on reception of the first signal and to measure second reception information on reception of the second signal; a second condition determining circuit configured to, when the first identification information and the second identification information are the same, compares the first reception information and the second reception information to determine whether a radio apparatus in an abnormal condition is present; and a second transmitting circuit configured to transmit a determination result of the second condition determining circuit to the first radio apparatus, in which the first radio apparatus includes: a first receiving circuit configured to receive the determination result from each of the plurality of second radio apparatuses; and a first condition determining circuit configured to determine whether a radio apparatus in an abnormal condition is present based on the determination results corresponding to the individual plurality of second radio apparatuses.

A radio apparatus according to one example of the present disclosure is an apparatus being is a first radio apparatus that belongs to a radio network, the first radio apparatus including: a receiving circuit configured to receive a determination result indicating whether a radio apparatus in an abnormal condition is present from each of a plurality of second radio apparatuses that belongs to the radio network, wherein the determination result is obtained by each of the plurality of second radio apparatuses receiving a first signal containing first identification information indicating a transmission source radio apparatus during a first reception period, receiving a second signal containing second identification information indicating a transmission source radio apparatus during a second reception period different from the first reception period, measuring first reception information on reception of the first signal, measuring second reception information on reception of the second signal, and when the first identification information and the second identification information are identical to each other, comparing the first reception information and the second reception information to determine whether a radio apparatus in an abnormal condition is present; and a first condition determining circuit configured to determine whether a radio apparatus in an abnormal condition is present based on the determination result corresponding to each of the plurality of second radio apparatuses.

It should be noted that a general or specific embodiment may be implemented as a system, an apparatus, a method, an integrated circuit, a computer program, a storage medium, or any selective combination thereof.

### Advantageous Effects of Invention

According to an embodiment of the present disclosure, it can be determined whether a radio terminal in an abnormal condition, such as being spoofed, is present.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a system configuration diagram showing an example of a radio sensor network system according to Embodiment 1;

FIG. 2 is a block diagram showing an example of the configuration of a controller according to Embodiment 1;

FIG. 3 is a block diagram showing an example of the configuration of a radio sensor according to Embodiment 1;

FIG. 4 is a flowchart showing an example of the operation of the radio sensor network system according to Embodiment 1;

FIG. 5 is a flowchart showing an operation for determining an abnormal terminal according to Embodiment 1;

FIG. 6A is a diagram showing an example of the arrangement of the radio sensors according to Embodiment 1;

FIG. 6B is a diagram showing an example of an arrangement in which a spoofing radio sensor is outside building R according to Embodiment 1;

FIG. 7A is a diagram showing an inter-terminal received signal strength indicator (RSSI) matrix collected in the example in FIG. 6A;

FIG. 7B is a diagram showing an inter-terminal RSSI matrix collected in the example in FIG. 6B;

FIG. 8 is a diagram showing an example of a system configuration in which a spoofing radio sensor is installed in the vicinity of a radio sensor according to Embodiment 1;

FIG. 9A is a diagram showing an example of the arrangement of the radio sensors according to Embodiment 1;

FIG. 9B is a diagram showing an example of an arrangement in which a spoofing radio sensor is in the vicinity of a radio sensor according to Embodiment 1;

FIG. 10A is a diagram showing an inter-terminal RSSI matrix collected in the example in FIG. 9A;

FIG. 10B is a diagram showing an inter-terminal RSSI matrix collected in the example in FIG. 9B;

FIG. 11 is a system configuration diagram showing an example of a radio sensor network system according to Embodiment 2;

FIG. 12 is a block diagram showing an example of the configuration of a controller according to Embodiment 2;

FIG. 13 is a block diagram showing an example of the configuration of a radio sensor according to Embodiment 2;

FIG. 14A is a diagram showing an example of an inter-terminal RSSI matrix recorded in a radio sensor according to Embodiment 2;

FIG. 14B is a diagram showing an example of an inter-terminal RSSI matrix recorded in a radio sensor in the example in FIG. 11;

FIG. 14C is a diagram showing an example of the determination result of the radio sensor based on FIGS. 14A and 14B;

FIG. 15A is a diagram showing an example of an inter-terminal RSSI matrix recorded in a radio sensor in the example in FIG. 6A;

FIG. 15B is a diagram showing an example of an inter-terminal RSSI matrix recorded in a radio sensor in the example in FIG. 6B;

FIG. 15C is a diagram showing an example of the determination result of the radio sensor based on FIGS. 15A and 15B;

FIG. 16 is a diagram showing an example of abnormal condition determined by the radio sensors according to Embodiment 2;

FIG. 17 is a diagram showing an example of the determination targets of the radio sensors according to Embodiment 2;

FIG. 18 is a diagram showing an example of the format of a determination-result notification packet in which a radio sensor reports the determination result according to Embodiment 2; and

FIG. 19 is a diagram showing an example of the field configuration of a determination-result notifier in the determination-result notification packet transmitted by a radio sensor according to Embodiment 2.

### DESCRIPTION OF EMBODIMENTS

Embodiments of the present disclosure will be described in detail hereinbelow with reference to the drawings. However, unnecessarily detailed descriptions maybe omitted. For example, detailed descriptions of well-known matters and redundant descriptions of substantially the same configurations may be omitted. This is for avoiding unnecessary redundancy in the following description, thereby facilitating the understanding of those skilled in the art.

The accompanying drawings and the following description are provided for those skilled in the art to understand the present disclosure sufficiently and are not intended to limit the subject of the claims.

Radio sensor network systems according to the embodiments of the present disclosure are applicable to a use case in which various sensors installed in a production line, inside and outside manufacturing equipment, or around a production line (or manufacturing equipment) in factories or manufacturing premises are integrated to a server serving as a controller.

The radio sensor network systems include a controller and a plurality of sensors. Each sensor includes a radio. The sensor including a radio may be hereinafter referred to as a radio sensor. The radio sensor network systems according to the embodiments of the present disclosure can detect a radio sensor in an abnormal condition, such as being spoofed.

In the embodiments of the present disclosure, a radio sensor in an abnormal condition is detected by taking advantage of the fact that one radio sensor (radio sensor #X) can easily receive a signal (packet) transmitted from another radio sensor (for example, radio sensor #Y).

For example, instead of the intensity of the received radio wave between the controller and the radio sensor, information of the received radio wave intensity of a signal that one radio sensor (radio sensor #A) has received from another radio sensor (radio sensor #B), regarded as matrix data, is used to detect a radio sensor in an abnormal condition from a change in the matrix of the received radio wave intensity.

### Embodiment 1

Embodiment 1 of the present disclosure will be described in detail with reference to the drawings.

<Description of System Configuration>

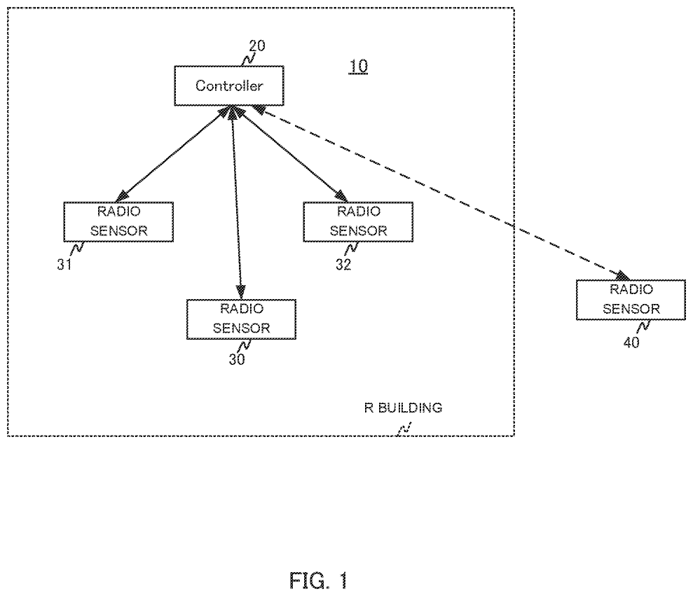

Radio sensor network system 10 according to Embodiment 1 will be described with reference to FIG. 1.

Radio sensor network system 10 includes controller 20 and radio sensors 30, 31, and 32. Controller 20 and radio sensors 30, 31, and 32 are examples of radio apparatuses that belong to radio sensor network system 10.

Controller 20 connects to radio sensors 30, 31, and 32 by radio. Controller 20 and radio sensors 30, 31, and 32 are installed in building R enclosed by the dotted line. The communication area of controller 20 and radio sensor 30, 31, and 32 does not have to coincide with the area of building R. For example, the communication area may be either wider or narrower than the area of building R.

Each radio sensors is assigned a unique identification information (for example, an identifier (ID) or a medium access control (MAC) address) for identifying the radio sensor. Authorized radio sensors do not include a plurality of radio sensors with the same ID. Unique IDs may be assigned to radio sensors, or radio sensors may each have a unique ID.

In this embodiment, radio sensor 40 is contained in the communication area of controller 20 and radio sensors 30, 31, and 32.

Radio sensor 40 is, for example, a radio sensor that spoofs radio sensor 30 and is an unauthorized radio sensor with the same ID as radio sensor 30. In the following example, the spoofing radio apparatus is “radio sensor”, but the spoofing radio apparatus is not limited to “radio sensor”. Examples of the “radio apparatus” include “radio communication apparatus”, “radio terminal”, “radio communication terminal”, “radio device”, and “radio communication device”.

Radio sensor 40 has the same ID as radio sensor 30. To spoof radio sensor 30, radio sensor 40 sets the ID of radio sensor 30 as the transmission source of the packet to be transmitted and transmits the packet in which radio sensor 30 is set as the transmission source. For this reason, radio sensors 31 and 32 and controller 20 that have received the packet transmitted by radio sensor 40 regards (determines) the packet transmitted by radio sensor as (to be) a packet transmitted by radio sensor 30.

Radio sensor network system 10 of Embodiment 1 determines (detects) whether radio sensor 40 that spoofs radio sensor 30 is present. The determination that radio sensor that spoofs radio sensor 30 is present may correspond the determination that radio sensor 30 is in an abnormal condition. In other words, for example, the fact that radio sensor 30 is in an abnormal condition includes a case where radio sensor 30 itself is in an abnormal condition and a case where radio sensor 30 is in a normal condition, but a radio sensor (for example, radio sensor 40) that spoofs radio sensor 30 is present.

In Embodiment 1, suppose that the IDs of radio sensors 30, 31, 32, and 40 are B, A, C, and β, respectively. For example, radio sensor 30 may be referred to as radio sensor B. For example, in Embodiment 1, radio sensor β is a radio sensor that spoofs radio sensor B.

### Configuration Example of Controller

Controller 20 determines whether the individual radio sensors are in an abnormal condition on the basis of inter-terminal received signal strength indicators (RSSIs) at an early stage collected when radio sensors 30, 31, and 32 are installed and inter-terminal RSSIs collected at some point in time after the installation.

The inter-terminal RSSI indicates a reception intensity, measured when one radio sensor received a packet from another radio sensor, between the two radio sensors, the intensity according to the distance between the two radio sensors, for example. The RSSIs at the early stage are inter-terminal RSSIs at an early stage at which radio sensors 30, 31, and 32 are installed. In other words, the inter-terminal RSSIs at the early stage may be reference inter-terminal RSSIs measured at a stage at which no unauthorized radio sensor is present. The abnormal condition of the radio sensor corresponds to, for example, a condition in which the radio sensor is not an authorized radio sensor. The terms “radio sensor” and “terminal” may be interchanged with each other. The inter-terminal RSSI may include an RSSI between two radio sensors and an RSSI between a radio sensor and controller 20.

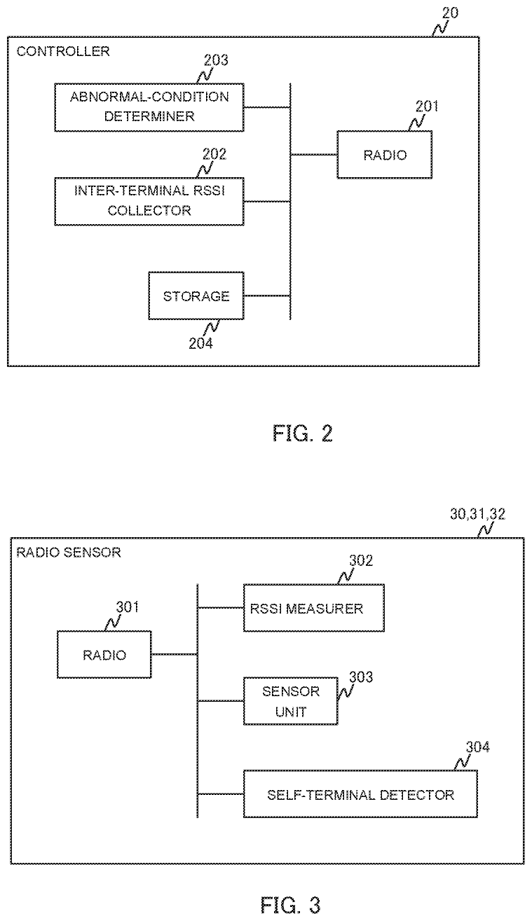

The configuration of controller 20 according to Embodiment 1 will be described with reference to FIG. 2.

Controller 20 includes radio 201, inter-terminal RSSI collector 202, abnormal-condition determiner 203, and storage 204.

Radio 201 performs radio communication with a radio sensor via an antenna. Radio 201 has the function of an access point that manages a star network, for example.

Examples of a communication method for radio 201 include a radio local area network (LAN) and Bluetooth(®). Other examples of a communication method for radio 201 include WiGig using a millimeter wave band and specified low power radio transmission. Still other examples of a communication method for radio 201 include a low power, wide area (LPWA) network, such as Sigfox, LoRa, or narrow band-Internet of Things (NB-IoT).

Inter-terminal RSSI collector 202 instructs the individual radio sensors to measure an inter-terminal RSSI. Inter-terminal RSSI collector 202 collects inter-terminal RSSIs that the individual radio sensors measured.

The RSSIs are illustrative only. Inter-terminal RSSI collector 202 may collect another information, such as signal reception information, reception quality information, or received-signal intensity information. Examples include a signal-to-interference and noise power ratio (SINR) and a signal-to-noise ratio (SNR).

Abnormal-condition determiner 203 detects a radio sensor in an abnormal condition on the basis of inter-terminal RSSIs at an early stage obtained at installation and inter-terminal RSSIs obtained after the installation.

Storage 204 stores inter-terminal RSSIs collected from radio sensors 30, 31, and 32.

### Configuration Example of Radio Sensor

Radio sensor 30 receives packets transmitted by radio sensors 31 and 32 other than radio sensor 30 and measures inter-terminal RSSIs on the basis of the received packets. Radio sensor 30 stores measured inter-terminal RSSIs in association with information on the transmission sources and transmits the stored inter-terminal RSSIs to controller 20. When radio sensor 30 receives a packet transmitted by a radio sensor that spoofs radio sensor 30, radio sensor 30 transmits a packet indicating detection of radio sensor 30 itself to controller 20.

In the following example, the configuration shown in FIG. 3 is the configuration of radio sensor 30.

Radio sensor 30 includes radio 301, RSSI measurer 302, sensor unit 303, and self-terminal detector 304.

Radio 301 performs radio communication with controller 20 via an antenna. Radio 301 has the function of a station in a star network, for example.

RSSI measurer 302, when having received a packet, measures the RSSI of the received packet.

Sensor unit 303 includes, for example, a photoelectronic sensor and transmits a detected sensor value to controller 20.

Examples of sensor include a fiber sensor, a displacement sensor, an image sensor, a proximity sensor, a microphotosensor, a rotary encoder, a vibration sensor, a contact sensor, an inclination sensor, a motion sensor, an illumination sensor, and a touch sensor, as well as a combination of a plurality of sensors. Radio sensor network system 10 may include a plurality of different sensors. For example, radio sensor 30, radio sensor 31, and radio sensor 32 may include different sensor.

Self-terminal detector 304 detects whether the ID of the transmission source of the received packet is the same as the ID of radio sensor 30. Radio sensor network system 10 of this embodiment will be described taking half-duplex communication as its radio system. In the half-duplex communication, the same radio sensor does not perform transmission and reception at the same time. For this reason, self-terminal detector 304 takes advantage of the fact that radio sensor 30 does not receive a packet with the ID of radio sensor 30 (a packet in which the ID of radio sensor 30 is set as the transmission source). The radio system may be full-duplex communication. In the full-duplex communication, the same radio sensor may perform transmission and reception at the same time. However, for example, radio sensor 30 can ascertain the time when radio sensor 30 has transmitted a packet. For this reason, in the full-duplex communication, self-terminal detector 304 can take advantage of the fact that radio sensor 30 does not receive a packet with the ID of radio sensor 30 at a time different from the transmission time.

Self-terminal detector 304 also detects whether self-terminal detector 304 has detected a packet with the same ID indicating the transmission source a redetermined time (for example, two or more) in a plurality of packets received in a predetermined time.

Self-terminal detector 304 transmits self-terminal detection information indicating the above detection result to controller 20.

<Operation Procedure of Radio Sensor Network System>

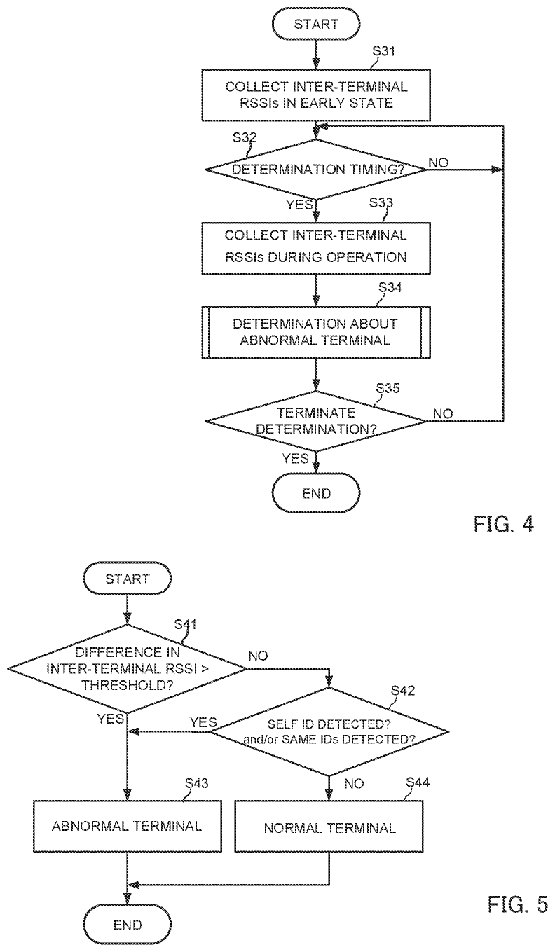

The operation procedure in FIG. 4 is started, for example, when radio sensor network system 10 is installed. Alternatively, this operation procedure may be started when a new radio sensor is added to the radio sensor network system 10, when the positions of the radio sensors has moved, and/or after the regular maintenance of the system 10.

In step S31, controller 20 instructs radio sensors 30, 31, and 32 to measure inter-terminal RSSIs to collect inter-terminal RSSIs in an early state (an example of a first reception period) at which radio sensors 30, 31, and 32 are installed. In step S31, when radio sensors 30, 31, and 32, which have received the instruction to measure inter-terminal RSSIs, receive a packet from another radio sensor, radio sensors 30, 31, and 32 measure the inter-terminal RSSIs based on the received packet and transmit the measured inter-terminal RSSIs to controller 20.

In one example, controller 20 transmits a packet that gives an instruction to measure inter-terminal RSSIs to radio sensors 30, 31, and 32 in sequence. In response to the packet that gives an instruction to measure the inter-terminal RSSIs, received from controller 20, radio sensors 30, 31, and 32 each transmit a packet containing information indicating the measured inter-terminal RSSI to controller 20. When radio sensors 30, 31, and 32 each receive a packet (for example, a packet containing information indicating an inter-terminal RSSI) that another radio sensor transmits to controller 20, the radio sensors 30, 31, and 32 each store the measured RSSI as an inter-terminal RSSI. Controller 20 transmits a packet that give an instruction to measure inter-terminal RSSIs until the controller 20 collects inter-terminal RSSIs from radio sensors present in the managed radio network.

Controller 20 stores the inter-terminal RSSIs (hereinafter sometimes referred to as “first inter-terminal RSSIs”) collected from radio sensors 30, 31, and 32. Then, the process in step S32 is executed.

In step S32, controller 20 determines whether it is the timing to determine whether a radio sensor in an abnormal condition is present. For example, the determination timing may be set to regular intervals. In this case, controller 20 may determine whether it is the determination timing on the basis of the set intervals.

When it is not the determination timing (NO in step S32), the process in step S32 is executed until the), the determination timing is reached. When it is the determination timing (YES in step S32), the process in step S33 is executed.

In step S33, controller 20 collects inter-terminal RSSIs from radio sensors 30, 31, and 32 during operation (an example of a second reception period), as in step S31. Controller 20 stores the inter-terminal RSSIs (hereinafter sometimes referred to as “second inter-terminal RSSIs”) collected from radio sensors 30, 31, and 32. The packets that the radio sensors use to measure the RSSI do not have to contain information indicating already measured inter-terminal RSSIs, as shown in step S31. For example, the radio sensors may receive a packet transmitted from another radio sensor and containing another information, such as sensor data, and measure the RSSIs. For example, radio sensors 30, 31, and 32 receive a packet (a packet containing another information, such as sensor data) that radio sensor 40 spoofing radio sensor 30 transmits to controller 20 and measure inter-terminal RSSIs between radio sensor 40 and the radio sensors 30, 31, and 32 themselves. Then, the process in step S34 is executed.

When radio sensor 30 receives a signal transmitted by radio sensor 40 that spoofs radio sensor 30, radio sensor 30 may transmit a packet containing self-terminal detection information to controller 20.

In step S34, controller 20 determines whether a radio sensor in an abnormal condition is present on the basis of the first inter-terminal RSSIs and the second inter-terminal RSSIs collected from radio sensors 30, 31, and 32 and the self-terminal detection information. The process in step S34 will be described below. Then, the process in step S35 is executed.

In step S34, controller 20 determines whether to terminate the determination of a radio sensor in an abnormal condition. Controller 20 may terminate the determination of a radio sensor in an abnormal condition, for example, when maintenance of radio sensor network system 10 (for example, repair of a radio sensor in an abnormal condition) is to be executed, when radio sensor network system 10 stops, when radio sensor network system 10 (for example, controller 20) enters a sleep mode, or when controller 20 executes collection of inter-terminal RSSIs in the early state (for example, S31) again,

When the determination of a radio sensor in an abnormal condition is not to be terminated (NO in S35), the process in step S32 is executed. When the determination of a radio sensor in an abnormal condition is to be terminated (YES in S35), the operation procedure in FIG. 4 ends.

<Operation Procedure for Determining Abnormal Terminal>

Referring next to FIG. 5, an example of determination of a radio sensor in an abnormal condition (hereinafter sometimes referred to as “abnormal terminal”) shown in step S34 of FIG. 4 will be described.

In step S41, controller 20 compares the first inter-terminal RSSIs and the second inter-terminal RSSIs obtained from radio sensors 30, 31, and 32. Controller 20 determines whether the differences between the first inter-terminal RSSIs and the second inter-terminal RSSIs are greater than a threshold. For example, the difference in inter-terminal RSSI may be an absolute value. The threshold may be a value greater than or equal to 0.

When the difference in inter-terminal RSSI is greater than the threshold (YES in step S41), controller 20 determines that a radio sensor (terminal) in an abnormal condition is present (step S43).

When the difference in inter-terminal RSSI is not greater than the threshold (NO in step S41), the process in step S42 is executed.

An example in which radio sensor 40 that spoofs radio sensor 30 makes an unauthorized access to controller 20 from a location different from the installation place of radio sensors 30, 31, and 32 will be described.

Radio sensor 40 spoofs, for example, radio sensor 30. For this reason, when controller 20 receives a packet transmitted from radio sensor 40, controller 20 may recognize that the received packet is a packet transmitted by radio sensor 30 by mistake. Furthermore, when controller 20 receives a packet transmitted by radio sensor 40, the RSSI measured by controller 20 may be changed by a change in surrounding radio wave environment. This makes it difficult to determine whether a radio sensor that spoofs radio sensor 30 is present on the basis of the RSSI measured by controller 20.

For this reason, controller 20 extracts radio sensor 40 that spoofs radio sensor 30 from a change in inter-terminal RSSIs measured by the individual radio sensors.

In step S42, controller 20 determines whether radio sensors 30, 31, and 32 have detected the IDs (own IDs) of the radio sensors 30, 31, and 32 themselves in the received packets and/or whether radio sensors 30, 31, and 32 have detected the same ID in a plurality of received packets a plurality of times. This determination may be based on, for example, self-terminal detection information. For this reason, the determination of the IDs (own IDs) is not performed, the radio sensors 30, 31, and 32 do not have to include self-terminal detector 304.

For example, when radio sensor 40 that spoofs radio sensor 30 is present, radio sensor 40 transmits a packet in which the same ID as the ID of radio sensor 30 is set as the transmission source. Radio sensor 30 recognizes that the ID of the transmission source of the received packet is the same as the ID of radio sensor 30 and determines that the radio sensor 30 has received a packet in which the ID of radio sensor 30 is set as the transmission source (for example, a packet that the radio sensor 30 cannot definitely receive). When controller 20 receives self-terminal detection information indicating this determination result, controller 20 determines that radio sensor 30 has detected the ID of radio sensor 30 (own ID) in the received packet.

For example, when radio sensor 40 that spoofs radio sensor 30 is present, radio sensor 40 transmits a packet in which the same ID as the ID of radio sensor 30 is set as the transmission source. For example, when radio sensors 31 and 32 receive a packet transmitted by radio sensor 30 and a packet transmitted by radio sensor 40 that spoofs radio sensor 30, radio sensors 31 and 32 determine that both of the IDs of the transmission sources of the two packets are the ID of radio sensor 30. When controller 20 receives self-terminal detection information indicating the determination result, controller 20 determines that radio sensors 31 and 32 have detected the same ID in the received packets a plurality of times.

Controller 20 can detect a spoofed radio sensor in an abnormal condition by using self-terminal detection information.

The following is an example in which radio sensor 40 that spoofs radio sensor 30 is installed in the vicinity of radio sensor 30. In this case, among inter-terminal RSSIs measured by radio sensor 31, the amount of change between the inter-terminal RSSI between radio sensor 31 and radio sensor 30 and the inter-terminal RSSI between radio sensor 31 and radio sensor 40 may be zero or extremely small. Controller 20 can detect a spoofed radio sensor in an abnormal condition by using self-terminal detection information collected from radio sensors 30, 31, and 32.

For example, when controller 20 is notified of self-terminal detection information (YES in step S42), controller 20 determines in step S43 that a radio sensor in an abnormal condition is present. For example, when self-terminal detection information is given from radio sensor 30, as in the above example, controller 20 determines that a radio sensor that spoofs radio sensor 30 is present.

When no self-terminal detection information is given (NO in step S42), controller determines that the radio sensor is a radio sensor in a normal condition and terminates the process.

### Example in Which Spoofing Radio Sensor Is Present Relatively Far

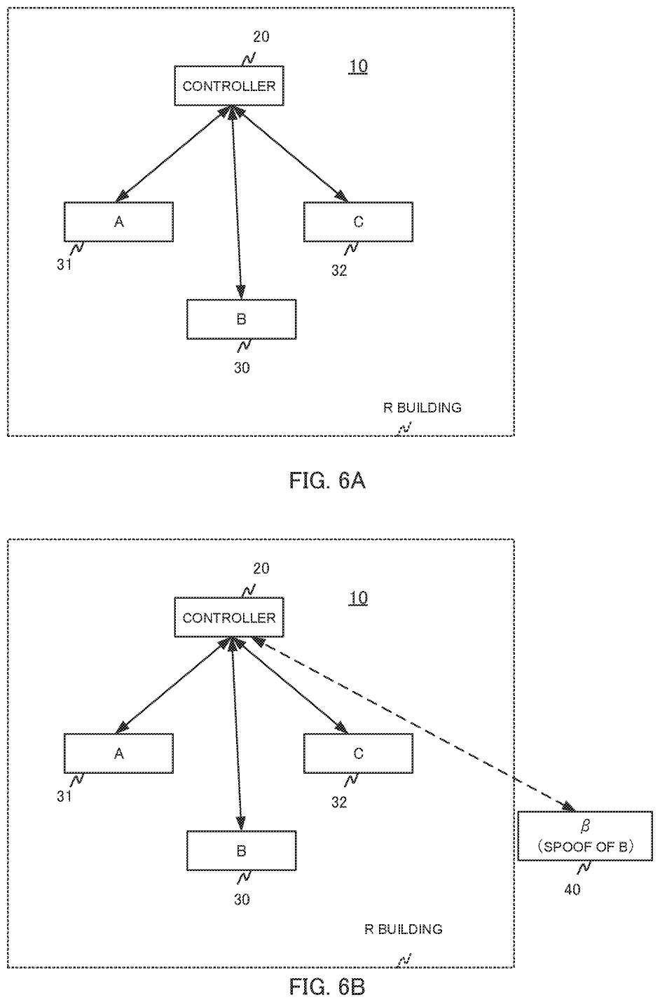

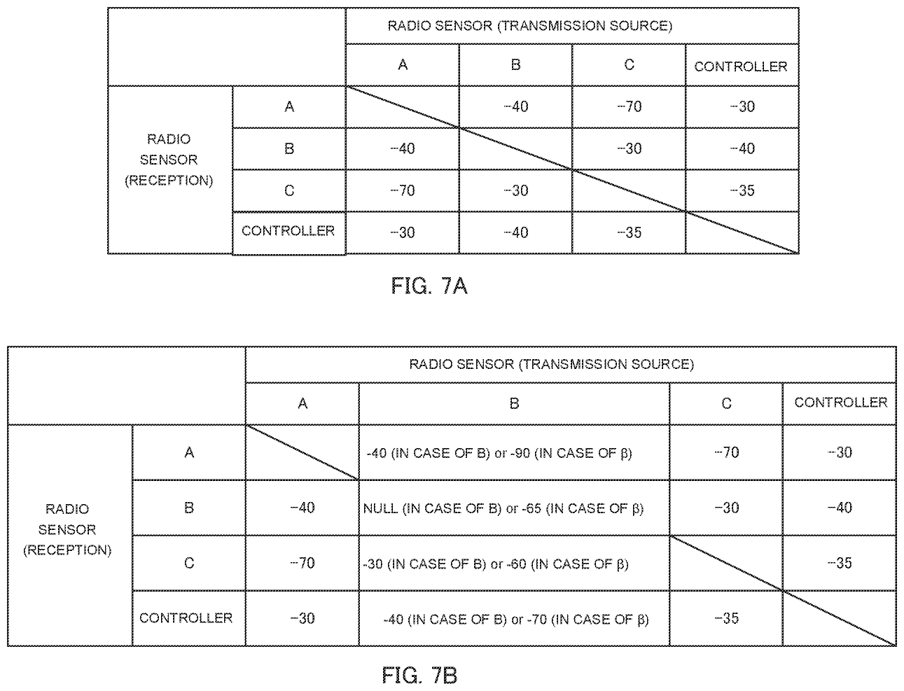

A method for detecting radio sensor 40 that spoofs radio sensor 30, when radio sensor is present far from radio sensor 30, will be described hereinbelow with reference to FIGS. 6A and 6B and FIGS. 7A and 7B.

Since FIG. 6A is the same as the example shown in FIG. 1, a detailed description thereof will be omitted. FIG. 6A shows, for example, an arrangement directly after radio sensor network system 10 is installed.

In FIG. 6B, the same as the components in FIG. 6A and FIG. 1 are given the same reference signs, and descriptions thereof are omitted.

Radio sensor 40 is a radio sensor that spoofs radio sensor 30 and has the same ID as radio sensor 30. Radio sensor 40 is present outside building R in which controller 20 and radio sensors 30, 31, and 32 are installed. Radio sensor 40 transmits a packet to controller 20 from outside of building R.

An example method for radio sensor 40 to spoof radio sensor 30 is that radio sensor sniffs a packet transmitted by radio sensor 30 to learn the operation of radio sensor 30.

First, controller 20 collects inter-terminal RSSIs from radio sensors 30, 31, and 32 connected by radio. When radio sensors 30, 31, and 32 receive a packet from another radio sensor, radio sensors 30, 31, and 32 measure inter-terminal RSSIs and store the inter-terminal RSSIs in association with the ID of the transmission source contained in the received packet. Any other method for radio sensors to measure inter-terminal RSSIs may be employed. For example, radio sensors may measure inter-terminal RSSIs by transmitting and receiving packets only for measuring inter-terminal RSSIs. Alternatively, another radio sensor may measure inter-terminal RSSIs by receiving packets for radio sensors to negotiate with controller 20.

Next, an inter-terminal RSSI matrix that controller 20 collects from the individual radio sensors and stores in the state of FIG. 6A will be described with reference to FIG. 7A.

In FIG. 7A, the individual rows show the IDs of radio sensors that have received packets and measured inter-terminal RSSIs from the received packets, and the individual columns show IDs set for the transmission sources of the packets used in measuring inter-terminal RSSIs.

For example, the row of ID “A” shows inter-terminal RSSIs measured by radio sensor 31. The inter-terminal RSSI measured by radio sensor 31 is −40 dBm in the case where radio sensor 30 is the transmission source, −70 dBm in the case where radio sensor 32 is the transmission source, and −30 dBm in the case where controller 20 is the transmission source. The row of ID “B” shows inter-terminal RSSIs measured by radio sensor 30, and the row of ID “C” shows inter-terminal RSSIs measured by radio sensor 32. The row of “controller” shows inter-terminal RSSIs measured by controller 20.

Controller 20 stores the inter-terminal RSSIs collected from the individual radio sensors, which are referred to as an inter-terminal RSSI matrix. An inter-terminal RSSI matrix at an early stage, collected at installation, is referred to as a first inter-terminal RSSI matrix. The inter-terminal RSSI matrix may also be referred to as a fingerprint.

Next, a case where radio sensor 40 that spoofs radio sensor 30 has gained unauthorized access will be described with reference to FIG. 7B.

FIG. 7B shows a case where radio sensor 40 that spoofs radio sensor 30 gains unauthorized access to transmit a packet with the ID of radio sensor 30. Radio sensors 30, 31, and 32 receive the packet in which the ID of radio sensor 30 is set as the transmission source.

The radio sensor 40 is located far from radio sensor 30. For this reason, an inter-terminal RSSI measured when radio sensor 31 receives the packet transmitted by radio sensor 40 is likely to change from an inter-terminal RSSI measured by radio sensor 31 which receives a packet transmitted from radio sensor 30. Also for radio sensor 32 and controller the inter-terminal RSSIs are likely to change, as for radio sensor 31.

FIG. 7B shows inter-terminal RSSIs separately between when radio sensor 30 (ID “B”) and radio sensor 40 (ID “β”) transmit packets for purpose of illustration.

The row of ID “A” shows inter-terminal RSSIs measured by radio sensor 31. The inter-terminal RSSI measured by radio sensor 31 is −40 dBm or −90 dBm in the case where radio sensor 30 is the transmission source, −70 dBm in the case where radio sensor 32 is the transmission source, and −30 dBm in the case where controller 20 is the transmission source. When radio sensor 31 receives a packet transmitted by radio sensor 40 that spoofs radio sensor 30 and measures the inter-terminal RSSI, radio sensor 31 determines that the measured inter-terminal RSSI is an inter-terminal RSSI in the case where radio sensor 30 is the transmission source. For this reason, in the case where radio sensor 30 is the transmission source, a value of −40 dBm or a value of −90 dBm is given.

The row of ID “B” shows inter-terminal RSSIs measured by radio sensor 30. Since radio sensor 30 receives a packet with the same ID as radio sensor 30, which cannot been received, radio sensor 30 stores self-terminal detection information together with the inter-terminal RSSI measured when receiving the packet with the same ID as radio sensor 30.

For the row of ID “C” and the row of ID “controller”, radio sensors 31 and 32 receive a packet transmitted by radio sensor 30 and a packet transmitted by radio sensor 40 that spoofs radio sensor 30, as in the row of ID “A”, and measure inter-terminal RSSIs from the two packets individually. Since the transmission sources of both of the packets are set to radio sensor 30, it is determined that the two inter-terminal RSSIs are inter-terminal RSSIs for radio sensor 30.

Controller 20 collects inter-terminal RSSIs from radio sensors 30, 31, and 32. Inter-terminal RSSIs collected during a predetermined time after the early stage are referred to as a second inter-terminal RSSI matrix.

Controller 20 compares the first and second inter-terminal RSSI matrices collected from radio sensors to detect a radio sensor in an abnormal condition due to spoofing.

A comparison of FIG. 7A and FIG. 7B shows that a change in inter-terminal RSSIs measured by other radio sensors is large, as well as the RSSI measured by controller 20. For this reason, controller 20 determines that radio sensor 30 is in an abnormal condition.

The inter-terminal RSSIs change according to the installation environment. For this reason, with the inter-terminal RSSIs measured by controller 20, it is difficult to determine whether the change in RSSI is due to a change in radio wave propagation or due to a difference in position between the radio sensors. Using a change in the inter-terminal RSSI matrix allows reduction of a change in radio wave propagation, allowing a radio sensor in an abnormal condition to be detected using the inter-terminal RSSIs measured by controller 20.

When controller 20 detects a radio sensor in an abnormal condition in the radio sensor network system 10, controller 20 may give an alert or display the system condition on a monitor.

### Example in Which Spoofing Radio Sensor Is Relatively Near

A case where radio sensor 40 that spoofs radio sensor 30 is in the vicinity of radio sensor 30 will be described hereinbelow with reference to the drawings.

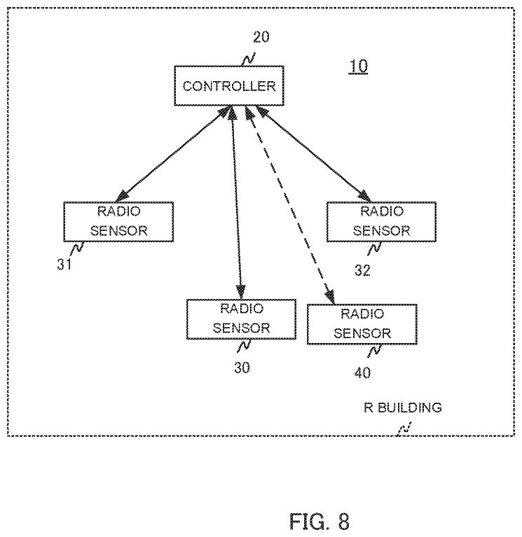

This differs from the example shown in FIG. 1 in that radio sensor 40 that spoofs radio sensor 30 in FIG. 1 is outside building R, while radio sensor 40 in FIG. 8 is in the vicinity of radio sensor 30 in building R.

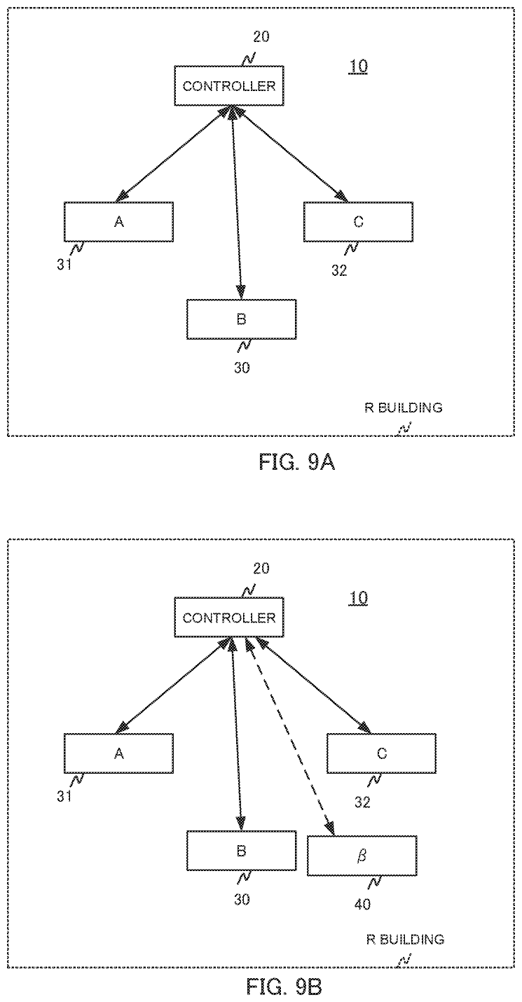

FIG. 9A is the same as the example shown in FIG. 1, and a description thereof will be omitted.

Radio sensor 40 shown in FIG. 9B is a radio sensor that spoofs radio sensor 30 as is radio sensor 40 shown in FIG. 6B and has the same ID as radio sensor 30. Radio sensor shown in FIG. 9B is present in building R in which controller 20 and radio sensors 30, 31, and 32 are installed and is present in the vicinity of radio sensor 30, unlike radio sensor shown in FIG. 6B. Radio sensor 40 transmits a packet to controller 20 from the vicinity of radio sensor 30.

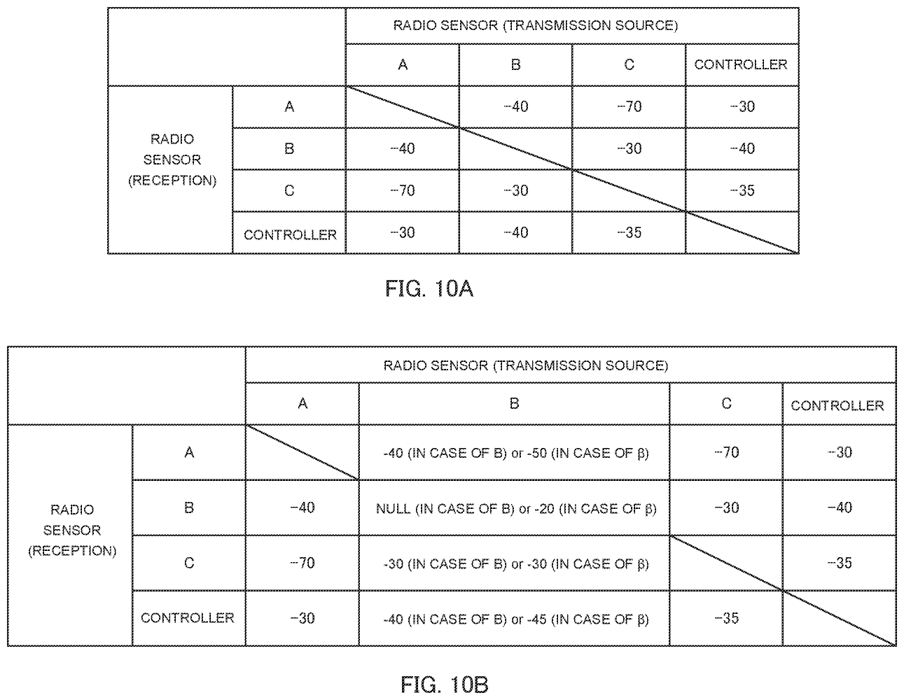

Since FIG. 9A is the same as FIGS. 1 and 6A, and FIG. 10A is the same inter-terminal RSSI matrix shown in FIG. 7A, a description of FIG. 10A will be omitted.

FIG. 10B shows a case where radio sensor 40 that spoofs radio sensor 30 is present in the vicinity of radio sensor 30. For example, an inter-terminal RSSI measured by radio sensor 31 when having received a packet transmitted by radio sensor 40 has no difference from or smaller than an inter-terminal RSSI measured when radio sensor 31 receives a packet transmitted by radio sensor 30. Similarly to radio sensor 31, inter-terminal RSSIs measured by radio sensor 32 and controller 20 when having received a packet from radio sensor 40 also have no difference from or smaller than an inter-terminal RSSI measured when receiving a packet transmitted by radio sensor 30.

Also in this case, when radio sensor 30 receives a packet transmitted by radio sensor radio sensor 30 determines that the transmission source of the received packet has the ID of radio sensor 30. Accordingly, radio sensor 30 transmits a packet containing self-terminal detection information to controller 20.

Also in the case where radio sensor 40 that spoofs radio sensor 30 is present in the vicinity of radio sensor 30, controller 20 determines that radio sensor 30 is in an abnormal condition on the basis of the self-terminal detection information received from radio sensor in addition to a change in the inter-terminal RSSI matrix (step S42 in FIG. 5).

As described above, Embodiment 1 shows a radio network system to which controller 20 and a plurality of radio sensors that connects to controller 20 by radio belong. For example, radio sensor 30 receives a first signal (for example, a packet) containing first identification information (for example, an ID) indicating a transmission source radio apparatus during a first reception period (for example, in an early state at system installation) and receives a second signal containing second identification information indicating a transmission source radio apparatus during a second reception period (for example, during operation) different from the first reception period. Radio sensor 30 measures first reception information (for example, RSSI) about reception of the first signal and measures second reception information about reception of the second signal. Radio sensor 30 transmits first measurement information containing the first reception information and the first identification information and second measurement information containing the second reception information and the second identification information to controller 20. Controller receives the first measurement information and the second measurement information from each of the plurality of radio sensors including radio sensor 30 and, when the first identification information and the second identification information are the same, compares the first reception information and the second reception information to determine whether a radio apparatus in an abnormal condition is present.

With this configuration, when radio sensor #Y that spoofs radio sensor #X is present, controller 20 determines whether spoofing radio sensor #Y is present by detecting a change in reception information (for example, inter-terminal RSSIs) among a plurality of radio sensors including radio sensor #X and radio sensor #Y.

For example, controller 20 receives measurement information indicating the result of measurement of inter-terminal RSSIs measured at an early stage and measurement information indicating the result of measurement of inter-terminal RSSIs measured after the early stage from each of the plurality of sensors. Controller 20 compares the inter-terminal RSSI matrix (first inter-terminal RSSI matrix) measured at the early stage and the inter-terminal RSSI matrix (second inter-terminal matrix) measured after the early stage to determine whether a radio sensor in an abnormal condition is present on the basis of the magnitude of a change in inter-terminal RSSI. This configuration allows determination based on the integrated measurement result of the plurality of radio sensors, allowing determination of whether a radio terminal in an abnormal condition, such as being spoofed, is present.

### Embodiment 2

Embodiment 2 of the present disclosure will be described in detail with reference to the drawing.

Embodiment 1 shows an example in which a controller collects inter-terminal RSSIs from the individual radio sensors and determines whether a radio sensor in an abnormal condition is present on the basis of the collected inter-terminal RSSI matrix.

In Embodiment 2, each radio sensor determines whether the radio sensor is in an abnormal condition, and the controller collects the results of determination and specifies a radio sensor in an abnormal condition.

<Description of System Configuration>

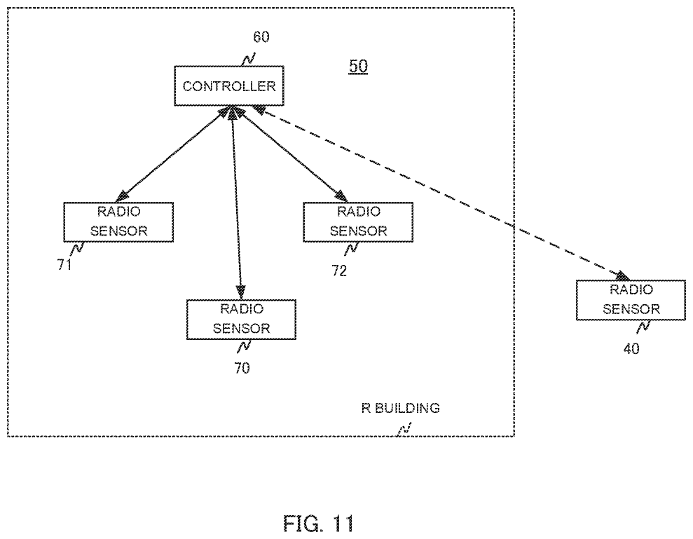

The system configuration of radio sensor network system 50 according to Embodiment 2 will be described with reference to FIG. 11.

Radio sensor network system 50 includes controller 60 and radio sensors 70, 71, and 72. Controller 60and radio sensors 70, 71, and 72 are examples of radio apparatuses that belong to radio sensor network system 50.

Controller 60 connects to radio sensors 70, 71, and 72 by radio. Controller 60 and radio sensors 70, 71, and 72 are installed in building R enclosed by the dotted line. The communication area of controller 60 and radio sensors 70, 71, and 72 does not have to coincide with building R.

In Embodiment 2, radio sensor 40 is contained in the communication area of controller 60 and radio sensors 70, 71, and 72.

Radio sensor 40 is a radio sensor that spoofs radio sensor 70 and an unauthorized radio sensor with the same ID as radio sensor 70.

In Embodiment 2, the IDs of radio sensors 70, 71, 72, and 40 are B, A, C, β, respectively. For example, radio sensor 70 may be referred to as radio sensor B. For example, in Embodiment 2, radio sensor β is a radio sensor that spoofs radio sensor B.

### Configuration Example of Controller

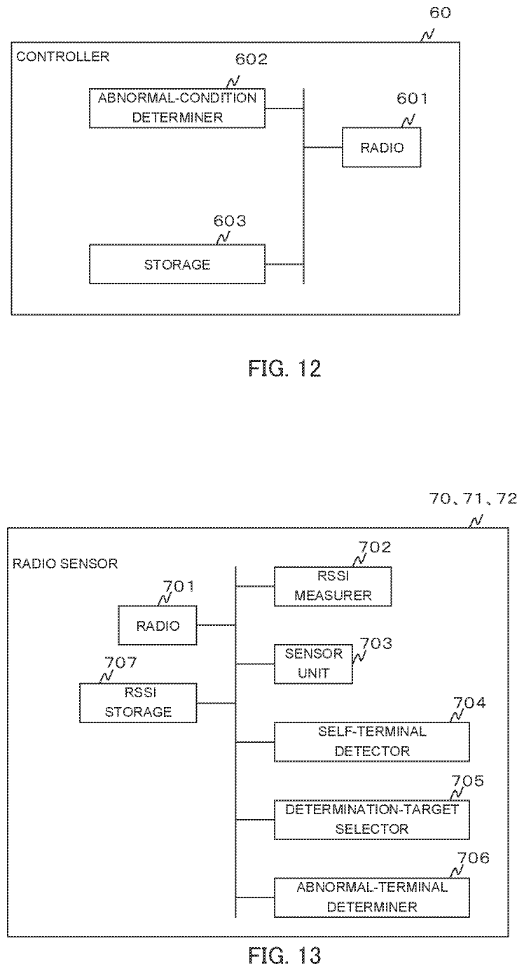

The configuration of controller 60 according to Embodiment 2 will be described with reference to FIG. 12.

Controller 60 includes radio 601, abnormal-condition determiner (first condition determiner) 602, and storage 603.

Since radio 601 has the same configuration as radio 201 shown in FIG. 2, a description thereof will be omitted.

Abnormal-condition determiner 602 determines whether a radio sensor in an abnormal condition is present on the basis of the results of determination of the individual radio sensors.

Storage 603 stores the result determined by each radio sensor.

### Configuration Example of Radio Sensor

In the following example, the configuration shown in FIG. 13 is the configuration of radio sensor 70.

Radio sensor 70 includes radio 701, RSSI measurer 702, sensor unit 703, self-terminal detector 704, determination-target selector 705, abnormal-terminal determiner (second condition determiner) 706, and RSSI storage 707.

Since radio 701, RSSI measurer 702, sensor unit 703, and self-terminal detector 704 have the same configuration as radio 301, RSSI measurer 302, sensor unit 303, and self-terminal detector 304 shown in FIG. 3, respectively, descriptions thereof will be omitted.

Determination-target selector 705 selects a determination target radio sensor of radio sensor 70. For example, determination-target selector 705 selects one from radio sensor 71 and radio sensor 72 that are contained in radio sensor network system 50 and connect to controller 60 by radio.

Abnormal-terminal determiner 706 determines whether the radio sensor selected by determination-target selector 705 is in an abnormal condition on the basis of the measured first and second inter-terminal RSSIs.

RSSI storage 707 stores inter-terminal RSSIs measured by RSSI measurer 702. Embodiment 1 shows an example in which controller 20 stores the inter-terminal RSSIs of the individual radio sensors, while, in Embodiment 2, radio sensor 70 stores inter-terminal RSSIs measured by radio sensor 70. Similarly to radio sensor 70, radio sensor 71 stores inter-terminal RSSIs measured by radio sensor 71, radio sensor 72 stores inter-terminal RSSIs measured by radio sensor 72, and controller 60 stores inter-terminal RSSIs measured by controller 60.

### Example of Inter-terminal RSSI

The inter-terminal RSSIs individually measured by radio sensors 70, 71, and 72 in Embodiment 2 are the same as the inter-terminal RSSIs measured by radio sensors 30, 31, and 32 in Embodiment 1. In Embodiment 2, however, the inter-terminal RSSIs are not integrated to the controller 60. Each of radio sensors 70, 71, and 72 stores the measured inter-terminal RSSIs and does not know the inter-terminal RSSIs measured by the other radio sensors.

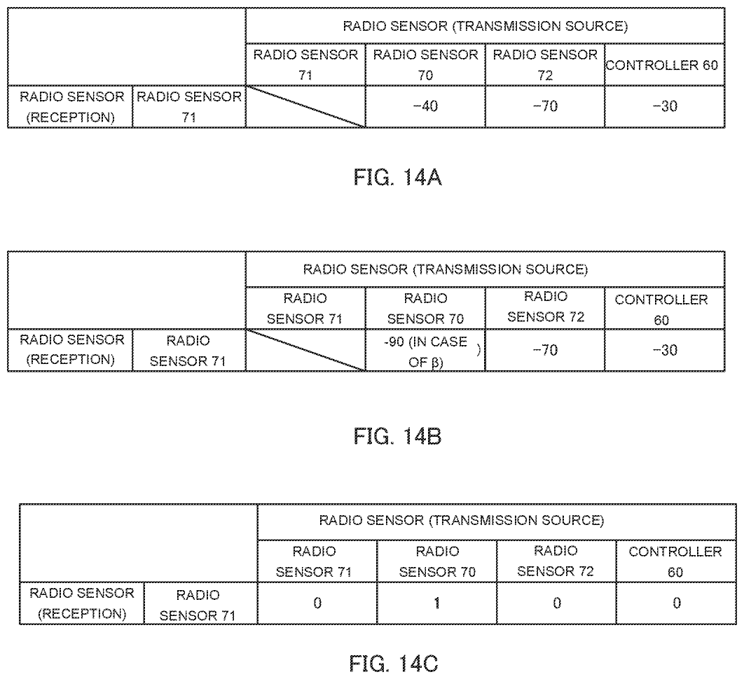

The inter-terminal RSSIs in Embodiment 2 will be described with reference to FIGS. 14A, to 14C.

The inter-terminal RSSI matrix shown in FIG. 14A is the same as the row of ID “A” in FIG. 7A and corresponds to a state in which radio sensor 40 is not present in radio sensor network system 50 shown in FIG. 11. The inter-terminal RSSI matrix shown in FIG. 14B is the same as the case where the ID of radio sensor 70 is β in the row of ID “A” shown in FIG. 7B and corresponds to the state of radio sensor network system 50 shown in FIG. 11.

Radio sensor 71 compares the first inter-terminal RSSI matrix shown in FIG. 14A and the second inter-terminal RSSI matrix shown in FIG. 14B and determines that radio sensor 70, which shows a change, to be a candidate of a radio sensor in an abnormal condition. Radio sensor 71 transmits information indicating the determination result to controller 60.

A packet containing the information indicating the determination result, transmitted by radio sensor 71, may contain the information on the candidate of the radio sensor determined to be in an abnormal condition and information on a radio sensor that is not determined to be in an abnormal condition.

Radio sensor 71 sets a value indicating a candidate of the radio sensor in an abnormal condition at “1” on the basis of the determination result, as shown in FIG. 14C, sets radio sensors that are not determined to be in an abnormal condition at “0”, creates a bitmap containing the individual values, and transmits the bitmap indicating the determination result to controller 60.

Similarly to radio sensor 71, radio sensor 72 and controller 60 also compare the inter-terminal RSSI matrices and determine that radio sensor 70 that shows a change as a candidate of a radio sensor in an abnormal condition (not shown).

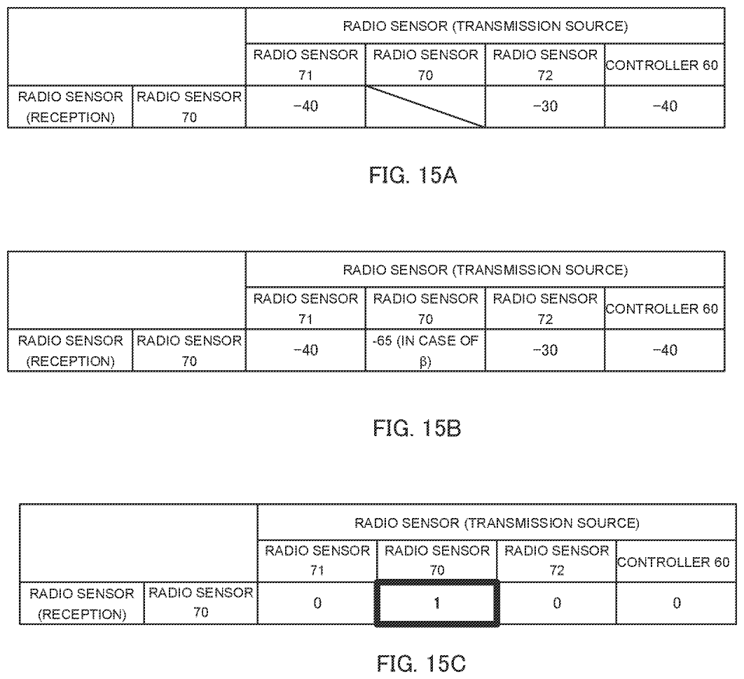

The inter-terminal RSSI matrix shown in FIG. 15A is the same as the row of ID “B” shown in FIG. 7A.

As shown in FIG. 15B, radio sensor 70 receives a packet in which the same ID as the ID of radio sensor 70, which cannot be received by radio sensor 70, is set as the transmission source. This packet is transmitted by radio sensor 40 that spoofs radio sensor 70. Radio sensor 70 transmits self-terminal detection information (for example, the information containing the shoutline cell in FIG. 15C) to controller 60.

Controller 60 integrates the determination results of radio sensors 70 to 72.

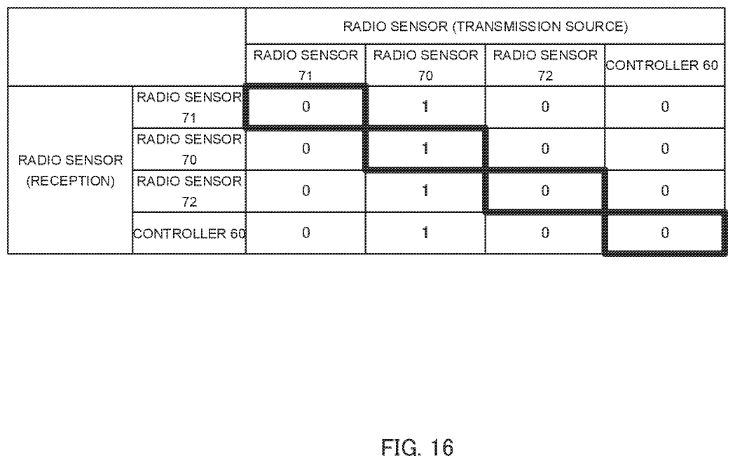

In the case of FIG. 16, the determination results received from the individual radio sensors 70, 71, and 72 indicate that radio sensor 70 is a candidate of a radio sensor in an abnormal condition. Controller 60 therefore determines that radio sensor 70 is a radio sensor in an abnormal condition.

Controller 60 may combine self-terminal detection information determined by the radio sensors to determine whether the radio sensors are radio sensors in an abnormal condition.

In the above example, controller 60 makes a determination on a candidate of a radio sensor in an abnormal condition in the determination results received from radio sensors 70, 71, and 72 to specify a radio sensor in an abnormal condition. The candidates of a radio sensor in an abnormal condition in the determination results of the radio sensors are not necessarily be the same. In this case, controller 60 can determine a radio sensor in an abnormal condition by using self-terminal detection information.

Controller 60 may determine that a radio sensor that is determined to be in an abnormal state by at least one of radio sensors 70, 71, and 72 is a radio sensor in an abnormal state on the basis of the determination results received from radio sensors 70, 71, and 72. However, since the radio sensors determine whether they are in an abnormal condition on the basis of the inter-terminal RSSIs, the determination result may differ among the radio sensors according to fluctuation of radio wave propagation.

For this reason, controller 60 may determine that a radio sensor that two or more of radio sensors 70, 71, and 72 determine to be in an abnormal condition to be a radio sensor in an abnormal condition. Alternatively, controller 60 may determine that a radio sensor that the majority of radio sensors 70, 71, and 72 determines to be a radio sensor in an abnormal condition to be a radio sensor in an abnormal condition.

The radio sensors indicate information on a candidate of a radio sensor in an abnormal condition using “1” or “0” in binary. Alternatively, the candidate information may be weighted.

For example, the individual radio sensors may weight the candidate information according to a temporal change in inter-terminal RSSI. Embodiment 2 takes an example in which a temporal change in inter-terminal RSSI between radio sensor 71 and radio sensor is smaller than a temporal change in inter-terminal RSSI between radio sensor 72 and radio sensor 70. In this example, in the process in which controller 60 determines whether radio sensor 70 is in an abnormal state, the determination result based on the inter-terminal RSSI of radio sensor 71 is more reliable than the determination result based on the inter-terminal RSSI of radio sensor 72. For this reason, the weight may be decreased as the temporal change in inter-terminal RSSI increases.

For example, when a change in inter-terminal RSSI measured by the individual radio sensors exceeds a threshold (when the change is large), the weight may be set at “0.5”. Not assigning a weight to each radio sensor but storing weighting coefficients in controller 60. For example, weighting coefficients may be determined by the individual radio sensors in advance, and controller 60 may be notified of the determined weighting coefficients. Notifying controller 60 of the weighting coefficients allows the amount of information to be reported by the radio sensors to be reduced. This is because, in the radio sensor network system, the information that radio sensors transmit is built-in sensor information, so that it is desirable to transmit less information.

This is a case where the individual radio sensors determine whether each of the radio sensors other than the radio sensor itself is in an abnormal state.

When the number of radio sensors contained in the radio sensor network system and connected to the controller increases, the amount of information indicating the determination result transmitted from the radio sensors to the controller increases. To prevent it, the target to be determined by each radio sensor may be determined in advance to reduce the number of radio sensors to be determined.

For example, radio sensors of high communication quality are determined to be the target using inter-terminal RSSIs measured by the radio sensors.

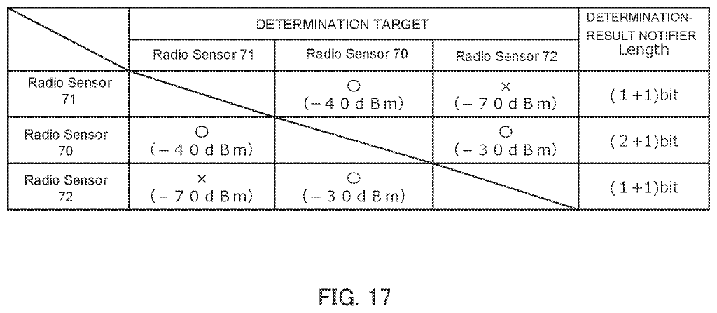

This will be described with reference to FIG. 7A. In FIG. 7A, −60 dBm is set as a threshold, and radio sensors with RSSIs greater than or equal to −60 dBm among the RSSIs measured by the radio sensors are determined to be the target. In this case, the determination targets of the radio sensors are shown in FIG. 17.

As shown in the row of “radio sensor 71” in FIG. 17, the inter-terminal RSSI of the packet transmitted by radio sensor 70 is −40 dBm, and radio sensor 71 determines that radio sensor 70 is a determination target. In contrast, the inter-terminal RSSI of the packet transmitted by radio sensor 72 is −70 dBm, which is less than the set threshold, and radio sensor 71 determines that radio sensor 72 is not a determination target.

Thus, radio sensor 71 determines whether radio sensor 70, which is a determination target, is in an abnormal condition, and does not determine whether radio sensor 72, which is not to a determination target, is in an abnormal condition. For this reason, the size (for example, bit length) of a field (determination-result notifier P82, described below) for reporting the determination result of radio sensor 71 only needs 2 bits plus a field to report self-terminal detection information.

Similarly, radio sensor 70 reports the determination result in 3 bits, that is, radio sensor 71 and radio sensor 72 plus a field for self-terminal detection information. Radio sensor 72 reports the determination result in 2 bits, that is, radio sensor 70 plus a field for self-terminal detection information.

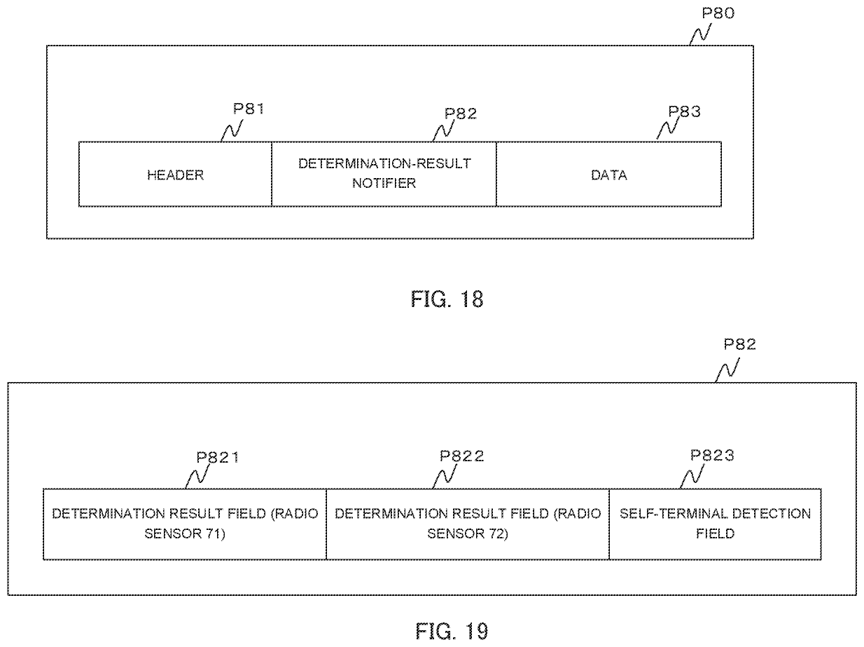

Referring to FIG. 18, a packet format of determination-result notification packet P80 in which the radio sensors according to Embodiment 2 report the determination result will be described.

Determination-result notification packet P80 includes header P81, determination-result notifier P82, and data P83.

Header P81 contain any or all of identification information (for example frame type) indicating the determination-result notification packet, identification information (for example, a MAC address, or a device ID) indicating a transmission source radio apparatus (for example, a radio sensor or a controller), and identification information (for example, a MAC address or a device ID) indicating a destination radio apparatus (for example, a radio sensor or a controller).

Determination-result notifier P82 contains information on a radio sensor that is determined by a radio sensor that transmits determination-result notification packet P80 to be in an abnormal condition.

Data P83 contains information that is obtained by the sensor unit of the radio sensor that transmits determination-result notification packet P80. Determination-result notification packet P80 does not have to include data P83.

Determination-result notification packet P80 may include an error determiner and an error corrector (not shown in FIG. 18).

Referring to FIG. 19, the field configuration of determination-result notifier P82 of determination-result notification packet P80 transmitted by radio sensor 70 according to Embodiment 2 will be described.

Determination-result notifier P82 includes determination result field P821, determination result field P822, and self-terminal detection field P823.

As shown in the second row of FIG. 17, radio sensor 70 notifies controller 60 of radio sensor 71, radio sensor 72, and self-terminal detection information.

Determination result field P821 shows the result of determination about radio sensor 71. For example, when radio sensor 70 determines that radio sensor 71 is an abnormal terminal, radio sensor 70 sets determination result field P821 at “1”, and when radio sensor 70 does not determine that radio sensor 71 is an abnormal terminal, radio sensor sets determination result field P821 at “0”.

Similarly to determination result field P821, determination result field P822 shows the result of determination about radio sensor 72.

Self-terminal detection field P823 shows that radio sensor 70 has received a packet with the ID of radio sensor 70. For example, when radio sensor 70 has received a packet with the ID of radio sensor 70, radio sensor 70 sets “1” in self-terminal detection field P823, and when not having received a packet with the ID of radio sensor 70, radio sensor 70 sets “0” in self-terminal detection field P823.

Thus, Embodiment 2 shows a radio network system to which controller 60 and a plurality of radio sensors (for example, radio sensors 70, 71, and 72) that connects to controller 60 by radio belong. For example, radio sensor 70 receives a first signal (for example, a packet) containing first identification information (for example, ID) indicating a transmission source radio apparatus during a first reception period (for example, at system installation) and receives a second signal containing second identification information indicating a transmission source radio apparatus during a second reception period (for example, during operation) different from the first reception period. Radio sensor 70 measures first reception information (for example, RSSIs) on the reception of the first signal and measures second reception information on the reception of the second signal. When the first identification information and the second identification information are the same, radio sensor 70 compares the first reception information and the second reception information to determine whether a radio apparatus in an abnormal condition is present and transmits the determination result to controller 60. Controller 60 receives determination results from the plurality of radio sensors including radio sensor 70 and determines whether a radio apparatus in an abnormal condition is present on the basis of the determination results.

With this configuration, when radio sensor #Y that spoofs radio sensor #X is present, controller 60 determines whether spoofing radio sensor #Y is present by detecting a change in inter-terminal RSSI among a plurality of radio sensors including radio sensor #X and radio sensor #Y.

For example, controller 60 receives comparison results from the plurality of radio sensors. The received comparison results are given by comparing the results of measurement of the inter-terminal RSSIs at an early stage and the results of measurement of the inter-terminal RSSIs after the early stage with the individual radio sensors. Controller determines whether a radio sensor in an abnormal condition is present on the basis of the comparison results. This configuration allows determination of a radio terminal in an abnormal condition, such as being spoofed.

Embodiment 2 shows an example in which each of the radio sensors makes a first determination based on the measured inter-terminal RSSIs and transmits the determination result to the controller. This configuration allows reduction of overhead of information transmitted from the radio sensors.

Although Embodiments 1 and 2 are described using an example in which the first inter-terminal RSSI is measured at an early stage at installation of the radio sensors, this is illustrative only. For example, the measurement may be made when a new radio sensor is added to the radio sensor network system and/or at regular maintenance.

Although a radio communication system using a single channel is employed as the radio system, a radio communication system using frequency hopping may be employed. In this case, the determination of an abnormal condition may be made on the basis of inter-terminal RSSIs measured with a plurality of hopping frequency channels.

Although the above embodiments uses a star radio network as its topology, the present disclosure can also be applied to a mesh network and a ring network. Although the above embodiments show examples in which the radio sensor network system includes one controller and three radio sensors, this is not intended to limit the present disclosure. For example, the radio sensor network system may include two or more controllers and four or more radio sensors. Alternatively, the radio sensor network system may include a radio apparatus different from the controller and the radio sensors.

Although the above embodiments show examples in which the radio sensors receive packets from the other radio sensors and the controller and measure inter-terminal RSSIs, this is not intended to limit the present disclosure. When a radio sensor does not receive a packet from some of the other radio sensors and the controller, the radio sensor does not have to measure the inter-terminal RSSI. For example, radio sensor #X does not have to receive a packet from another radio sensor #Y or controller outside the communication area of radio sensor #X and does not have to measure an inter-terminal RSSI. In this case, some factor of the inter-terminal RSSI matrix may be “blank”.

Although the above embodiments take a radio sensor network system as an example, this is not intended to limit the present disclosure. The present disclosure may be applied to a radio network different from the radio sensor network.

Although spoofing is taken as an example of the abnormal condition of the radio sensors, this is not intended to limit the present disclosure. For example, the abnormal condition of the radio sensors may be an unauthorized access of a radio sensor with an ID not registered in the controller or an abnormal condition (a decrease in transmission power of the radio) due to a failure of the radio sensor. In the above embodiments, such abnormal conditions can also be detected as is spoofing.

The above embodiments determine whether the radio sensors are in an abnormal condition using a difference in inter-terminal RSSI matrix. Alternatively, an inter-terminal RSSI matrix (for example, the first inter-terminal RSSI matrix) obtained at an early stage (for example, at installation) may be obtained multiple times at the early stage, and the obtained inter-terminal RSSI matrices may be used as training data. The controller may make a determination of an abnormal terminal using the training data obtained and learned at the early stage and the obtained inter-terminal RSSIs.

In the above embodiments, the term “unit” for use in the components may be replaced with another term, such as “circuit (circuitry)”, “assembly” “device”, “unit”, or “module”.

Having described the embodiments with reference to the drawings, it is to be understood that the present disclosure is not limited to the examples described above. It is to be understood that various modifications or changes will be apparent to those skilled in the art within the scope of the claims. It is therefore to be understood that such modifications and changes are within the technical scope of the present disclosure. The components in the embodiments may be freely combined without departing from the scope and spirit of the present disclosure.

The present disclosure can be realized by software, hardware, or software cooperating with hardware. The functional blocks used in illustrating the above embodiments may be realized as a large-scale integrated circuit (LSI) partly or as a whole, and the processes described in the embodiments may be controlled by one LSI or a combination of LSIs. The LSIs may be constituted by separate chips or may be formed of one chip including some or all of the functional blocks. The LSIs may include an input and an output of data. Depending on a difference in the degree of integration, the LSI may be referred to as an IC, a system LSI, a super LSI, or a super-ultra LSI.

The integrated circuit is not limited to the LSI. The integrated circuit may be implemented by a dedicated circuit, a general-purpose processor, or a dedicated processor. After an LSI is produced, a field programmable gate array (FPGA) or a reconfigurable processor capable of reconfiguring connections and settings of circuit cells in the LSI may be used. The present disclosure may be implemented as digital processing or analog processing.

Furthermore, when an integrated circuit technique that replaces the LSI due to advances in semiconductor technology or another derived technology appears, the technology may of course be used to integrate the functional blocks. An applicable example is biotechnology.

The present disclosure can be implemented in all kinds of apparatuses, devices, systems having a communication function (generically referred to as communication apparatuses). The communication apparatuses may include a radio transceiver and a processing/control circuit. The radio transceiver may include a receiver and a transmitter or include the receiver and the transmitter as the functions thereof. The radio transceiver (transmitter and receiver) may include a radio frequency (RF) module and one or a plurality of antennas. The RF module may include an amplifier, an RF modulator/demodulator, or the like. Non-limiting examples of the communication apparatus include telephones (mobile phones, smartphones, and the like), tablets, personal computers (PCs) (lap-top, desktop, notebook, and the like), cameras (digital still/video cameras and the like), digital players (digital audio/video players and the like), wearable devices (wearable cameras, smartwatches, tracking devices, and the like), game consoles, digital book readers, telehealth telemedicine (remote healthcare medicine prescription) devices, vehicles or mobile transportation facilities with a communication function (automobiles, airplanes, ships, and the like), and combinations of the above apparatuses.

The communication apparatuses are not limited to portable or movable apparatuses and include all kinds of non-portable or fixed apparatuses, devices, and systems, for example, smart home devices (household electrical appliances, illumination equipment, smartmeter or measurement hardware, control panels, and the like), automatic vending machines, and any other “things” that can be present on an Internet of Things (IoTs) network.

The communication includes data communication using a cellular system, a radio LAN system, or a communication satellite system, as well as data communication using a combination thereof.

The communication apparatuses further include controllers, sensors, and other devices connected or linked to a communication device that executes the communication function described in an embodiment of the present disclosure. Examples include controllers and sensors that generate control signals or data signals executed by the communication device that executes the communication function of the communication apparatuses.

Other examples of the communication apparatuses include infrastructure facilities that communicate with or control the various non-limiting apparatuses described above, for example, base stations, access points, and any other apparatuses, devices, and systems.

### SUMMARY OF THE PRESENT DISCLOSURE

A radio network system according to one example of the present disclosure is a system to which a first radio apparatus performing central control and a plurality of second radio apparatuses connected to the first radio apparatus by radio belong, in which each of the plurality of second radio apparatuses includes: a second receiving circuit configured to receive a first signal containing first identification information indicating a transmission source radio apparatus during a first reception period and to receive a second signal containing second identification information indicating a transmission source radio apparatus during a second reception period different from the first reception period; a measuring circuit configured to measure first reception information on reception of the first signal and to measure second reception information on reception of the second signal; and a second transmitting circuit configured to transmit first measurement information containing the first reception information and the first identification information and second measurement information containing the second reception information and the second identification information to the first radio apparatus, and in which the first radio apparatus includes: a first receiving circuit configured to receive the first measurement information and the second measurement information from each of the plurality of second radio apparatuses; and a condition determining circuit configured to, when the first identification information contained in the received first measurement information and the second identification information contained in the received second measurement information are identical to each other, compare the first reception information contained in the received first measurement information and the second reception information contained in the received second measurement information to determine whether a radio apparatus in an abnormal condition is present.

In the radio network system according to one example of the present disclosure, when a difference between the first reception information contained in the received first measurement information and the second reception information contained in the received second measurement information is greater than or equal to a threshold, the condition determining circuit determines that the radio apparatus in an abnormal condition is present.

In the radio network system according to one example of the present disclosure, the second radio apparatus further includes a detecting circuit configured to detect whether either of the first identification information and the second identification information contains identification information on the second radio apparatus, in which the second transmitting circuit transmits a detection result of the detecting circuit to the first radio apparatus, in which the first receiving circuit of the first radio apparatus receives the detection result, and in which, when the detection result indicates that the identification information indicating the second radio apparatus is contained, the condition determining circuit determines that a transmission source of the second signal is a radio apparatus in an abnormal condition.

A radio apparatus according to one example of the present disclosure is an apparatus being a first radio apparatus that belongs to a radio network, the first radio apparatus including: a receiving circuit configured to receive first measurement information and second measurement information from each of a plurality of second radio apparatuses connected to the first radio apparatus, wherein the first measurement information contains first reception information on reception of a first signal received during a first reception period and first identification information contained in the first signal, the first identification information indicating a transmission source radio apparatus, and wherein the second measurement information contains second reception information on reception of a second signal received during a second reception period different from the first reception period and second identification information contained in the second signal, the second identification information indicating a transmission source radio apparatus; and a first condition determining circuit configured to, when the first identification information and the second identification information are identical to each other, compares the first reception information and the second reception information to determine whether a radio apparatus in an abnormal condition is present.

A radio network system according to one example of the present disclosure is a system to which a first radio apparatus that performs central control and a plurality of second radio apparatuses connected to the first radio apparatus by radio belong, in which each of the plurality of second radio apparatuses includes: a second receiving circuit configured to receive a first signal containing first identification information indicating a transmission source radio apparatus during a first reception period and to receive a second signal containing second identification information indicating a transmission source radio apparatus during a second reception period different from the first reception period; a measuring circuit configured to measure first reception information on reception of the first signal and to measure second reception information on reception of the second signal; a second condition determining circuit configured to, when the first identification information and the second identification information are the same, compares the first reception information and the second reception information to determine whether a radio apparatus in an abnormal condition is present; and a second transmitting circuit configured to transmit a determination result of the second condition determining circuit to the first radio apparatus, in which the first radio apparatus includes: a first receiving circuit configured to receive the determination result from each of the plurality of second radio apparatuses; and a first condition determining circuit configured to determine whether a radio apparatus in an abnormal condition is present based on the determination results corresponding to the individual plurality of second radio apparatuses.

In the radio network system according to one example of the present disclosure, when a difference between the first reception information contained in the received first measurement information and the second reception information contained in the received second measurement information is greater than or equal to a threshold, the second condition determining circuit determines that the radio apparatus in an abnormal condition is present.

In the radio network system according to one example of the present disclosure, the second radio apparatus further includes: a detecting circuit configured to detect whether either of the first identification information and the second identification information contains identification information on the second radio apparatus, in which, when the detection result of the detecting circuit indicates that the identification information indicating the second radio apparatus is contained, the second condition determining circuit determines that a transmission source of the second signal is the radio apparatus in an abnormal condition.

A radio apparatus according to one example of the present disclosure is an apparatus being is a first radio apparatus that belongs to a radio network, the first radio apparatus including: a receiving circuit configured to receive a determination result indicating whether a radio apparatus in an abnormal condition is present from each of a plurality of second radio apparatuses that belongs to the radio network, wherein the determination result is obtained by each of the plurality of second radio apparatuses receiving a first signal containing first identification information indicating a transmission source radio apparatus during a first reception period, receiving a second signal containing second identification information indicating a transmission source radio apparatus during a second reception period different from the first reception period, measuring first reception information on reception of the first signal, measuring second reception information on reception of the second signal, and when the first identification information and the second identification information are identical to each other, comparing the first reception information and the second reception information to determine whether a radio apparatus in an abnormal condition is present; and a first condition determining circuit configured to determine whether a radio apparatus in an abnormal condition is present based on the determination result corresponding to each of the plurality of second radio apparatuses.

### INDUSTRIAL APPLICABILITY

The present disclosure is useful for radio sensor network systems.

### REFERENCE SIGNS LIST

10 Radio sensor network system
20, 60 Controller
30, 31, 32, 40, 70, 71, 72 Radio sensor
201, 301, 601, 701 Radio
202 Inter-terminal RSSI collector
203, 602 Abnormal-condition determiner
204, 603 Storage
302, 702 RSSI measurer
303, 703 Sensor unit
304, 704 Self-terminal detector
705 Determination-target selector
706 Abnormal-terminal determiner
707 RSSI storage

1. A radio network system to which a first radio apparatus performing central control and a plurality of second radio apparatuses connected to the first radio apparatus by radio belong,
wherein each of the plurality of second radio apparatuses comprises:
a second receiving circuit configured to receive a first signal containing first identification information indicating a transmission source radio apparatus during a first reception period and to receive a second signal containing second identification information indicating a transmission source radio apparatus during a second reception period different from the first reception period;
a measuring circuit configured to measure first reception information on reception of the first signal and to measure second reception information on reception of the second signal; and
a second transmitting circuit configured to transmit first measurement information containing the first reception information and the first identification information and second measurement information containing the second reception information and the second identification information to the first radio apparatus, and
wherein the first radio apparatus includes:
a first receiving circuit configured to receive the first measurement information and the second measurement information from each of the plurality of second radio apparatuses; and
a condition determining circuit configured to, when the first identification information contained in the received first measurement information and the second identification information contained in the received second measurement information are identical to each other, compare the first reception information contained in the received first measurement information and the second reception information contained in the received second measurement information to determine whether a radio apparatus in an abnormal condition is present.

2. The radio network system according to claim 1, wherein, when a difference between the first reception information contained in the received first measurement information and the second reception information contained in the received second measurement information is greater than or equal to a threshold, the condition determining circuit determines that the radio apparatus in an abnormal condition is present.

3. The radio network system according to claim 1,
wherein the second radio apparatus further includes
a detecting circuit configured to detect whether either of the first identification information and the second identification information contains identification information on the second radio apparatus,
wherein the second transmitting circuit transmits a detection result of the detecting circuit to the first radio apparatus,
wherein the first receiving circuit of the first radio apparatus receives the detection result, and
wherein, when the detection result indicates that the identification information indicating the second radio apparatus is contained, the condition determining circuit determines that a transmission source of the second signal is a radio apparatus in an abnormal condition.

4. A radio apparatus being a first radio apparatus that belongs to a radio network, the first radio apparatus comprising:
a receiving circuit configured to receive first measurement information and second measurement information from each of a plurality of second radio apparatuses connected to the first radio apparatus, wherein the first measurement information contains first reception information on reception of a first signal received during a first reception period and first identification information contained in the first signal, the first identification information indicating a transmission source radio apparatus, and wherein the second measurement information contains second reception information on reception of a second signal received during a second reception period different from the first reception period and second identification information contained in the second signal, the second identification information indicating a transmission source radio apparatus; and
a first condition determining circuit configured to, when the first identification information and the second identification information are identical to each other, compares the first reception information and the second reception information to determine whether a radio apparatus in an abnormal condition is present.

5. A radio network system to which a first radio apparatus that performs central control and a plurality of second radio apparatuses connected to the first radio apparatus by radio belong,
wherein each of the plurality of second radio apparatuses comprises:
a second receiving circuit configured to receive a first signal containing first identification information indicating a transmission source radio apparatus during a first reception period and to receive a second signal containing second identification information indicating a transmission source radio apparatus during a second reception period different from the first reception period;
a measuring circuit configured to measure first reception information on reception of the first signal and to measure second reception information on reception of the second signal;
a second condition determining circuit configured to, when the first identification information and the second identification information are the same, compares the first reception information and the second reception information to determine whether a radio apparatus in an abnormal condition is present; and
a second transmitting circuit configured to transmit a determination result of the second condition determining circuit to the first radio apparatus,
wherein the first radio apparatus includes:
a first receiving circuit configured to receive the determination result from each of the plurality of second radio apparatuses; and
a first condition determining circuit configured to determine whether a radio apparatus in an abnormal condition is present based on the determination results corresponding to the individual plurality of second radio apparatuses.

6. The radio network system according to claim 5, wherein, when a difference between the first reception information contained in the received first measurement information and the second reception information contained in the received second measurement information is greater than or equal to a threshold, the second condition determining circuit determines that the radio apparatus in an abnormal condition is present.

7. The radio network system according to claim 5,
wherein the second radio apparatus further includes:
a detecting circuit configured to detect whether either of the first identification information and the second identification information contains identification information on the second radio apparatus,
wherein, when the detection result of the detecting circuit indicates that the identification information indicating the second radio apparatus is contained, the second condition determining circuit determines that a transmission source of the second signal is the radio apparatus in an abnormal condition.

8. A radio apparatus being is a first radio apparatus that belongs to a radio network, the first radio apparatus comprising:
a receiving circuit configured to receive a determination result indicating whether a radio apparatus in an abnormal condition is present from each of a plurality of second radio apparatuses that belongs to the radio network, wherein the determination result is obtained by each of the plurality of second radio apparatuses receiving a first signal containing first identification information indicating a transmission source radio apparatus during a first reception period, receiving a second signal containing second identification information indicating a transmission source radio apparatus during a second reception period different from the first reception period, measuring first reception information on reception of the first signal, measuring second reception information on reception of the second signal, and when the first identification information and the second identification information are identical to each other, comparing the first reception information and the second reception information to determine whether a radio apparatus in an abnormal condition is present; and
a first condition determining circuit configured to determine whether a radio apparatus in an abnormal condition is present based on the determination result corresponding to each of the plurality of second radio apparatuses.
